(19) United States
(12) Patent Application Publication
(10) Pub. No.: US 2017/0300896 A1
(43) Pub. Date: Oct. 19, 2017

(54) OMNI-CHANNEL DATA PROCESSING USING HIERARCHICAL VAULT DATA STRUCTURES

(71) Applicant: PayPal, Inc., San Jose, CA (US)

(72) Inventors: Prashant Jamkhedkar, Fremont, CA (US); Teddy Vincent Toms, San Jose, CA (US); Haoyu Xue, San Jose, CA (US); Abhijeet Arvind Ranadive, San Jose, CA (US)

(21) Appl. No.: 15/347,343

(22) Filed: Nov. 9, 2016

Related U.S. Application Data
(60) Provisional application No. 62/321,827, filed on Apr. 13, 2016.

(51) Int. Cl. G06Q 20/36; G06Q 20/10

(52) U.S. Cl. CPC G06Q 20/36; G06Q 20/102

(57) ABSTRACT

Methods, systems, and computer program products are included for electronic provisioning and transactions. These methods, systems, and computer program products expose communicatively coupled components in an electronic payment framework to provide electronic omni-channel payments using a hierarchy of vault data stores. Various aspects of this framework include provisioning a tender and using the provisioned tender as part of a transaction. This framework may be used in the context of in-store, private label card, and e-commerce payments. An example method of performing an electronic transaction includes transmitting a client token from a merchant application to a white label platform. The white label platform determines a billing agreement identifier that corresponds to the client token. The white label platform transmits the billing agreement identifier to a consumer vault provider. The consumer vault provider receives the billing agreement identifier and processes a payment corresponding to the billing agreement identifier.

### CROSS-REFERENCE TO RELATED APPLICATIONS

This application claims priority from U.S. Provisional Application No. 62/321,827, filed Apr. 13, 2016, which is incorporated herein by reference in its entirety.

### FIELD OF DISCLOSURE

The present disclosure generally relates to electrical computers and digital data processing, and more particularly relates to electronic transaction processing and multicomputer data transferring.

### BACKGROUND

Consumers have many options for conducting transactions, such as purchasing items and services, over electronic networks and via in-store transactions. Items and services may be are routinely purchased from merchants and individuals alike. Many of these transactions are performed using private label cards and electronic consumer wallets. For example, a consumer may store funds in an electronic wallet offered by PAYPAL® or other electronic wallet provider. Funds that are stored in electronic wallets may then be transferred from individuals to other individuals or merchants. Another payment option is private label cards. Private label cards include cards that are produced by a company and re-branded by a merchant to make it appear as though the merchant is the card producer.

### SUMMARY

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system including: a non-transitory memory; and one or more hardware processors coupled to the non-transitory memory and configured to read instructions from the non-transitory memory to cause the system to perform operations including: provisioning a consumer vault provider to provide finds. The provisioning includes generating a client token by a server component of a white label service provider. The provisioning also includes providing the client token to a merchant application. The provisioning also includes initializing, using the client token at the merchant application, a client component corresponding to the white label service provider. The provisioning also includes providing a billing agreement, at least in part by one or more operations performed by the client component and the consumer vault provider, the billing agreement corresponding to a billing agreement identifier. The provisioning also includes providing the billing agreement identifier to the white label service provider; and after provisioning the consumer vault provider, performing a transaction using the provisioned funds. The transaction includes transmitting the client token from the merchant application to a white label platform. The transaction also includes determining, by the white label platform, the billing agreement identifier that corresponds to the client token. The transaction also includes transmitting the billing agreement identifier from the white label platform to the consumer vault provider. The transaction also includes processing, by the consumer vault provider, a payment corresponding to the billing agreement identifier. Other embodiments of this aspect include corresponding computer systems, apparatus, and computer programs recorded on one or more computer storage devices, each configured to perform the actions of the methods.

One general aspect includes a non-transitory machine-readable medium having stored thereon machine-readable instructions executable to cause a machine to perform operations including: transmitting a client token from a merchant application to a white label platform; determining, by the white label platform, a billing agreement identifier that corresponds to the client token; transmitting the billing agreement identifier from the white label platform to a consumer vault provider; and processing, by the consumer vault provider, a payment corresponding to the billing agreement identifier. Other embodiments of this aspect include corresponding computer systems, apparatus, and computer programs recorded on one or more computer storage devices, each configured to perform the actions of the methods.

One general aspect includes a method for performing an electronic transaction including: transmitting a client token from a merchant application to a white label platform; determining, by the white label platform, a billing agreement identifier that corresponds to the client token; transmitting the billing agreement identifier from the white label platform to a consumer vault provider; and processing, by the consumer vault provider, a payment corresponding to the billing agreement identifier. Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention is illustrated by way of example and not limitation in the figures of the accompanying drawings.

FIG. 1 is a block diagram illustrating a system architecture for providing a hierarchical vault data structure, in accordance with various examples of the present disclosure.

FIG. 2 is a block diagram illustrating a computer system suitable for implementing one or more devices of the computing system in FIG. 1.

FIG. 3 is a block diagram illustrating a hierarchical vault data structure, in accordance with various examples of the present disclosure.

FIG. 4 illustrates a sequence diagram for provisioning an electronic wallet of a consumer vault provider as tender for in-store merchant transactions, in accordance with various examples of the present disclosure.

FIG. 5 illustrates a sequence diagram for performing an in-store transaction using an electronic wallet of a consumer vault provider that has been provisioned as tender for in-store merchant transactions, in accordance with various examples of the present disclosure.

FIG. 6 illustrates a sequence diagram for provisioning a private label card as tender for in-store merchant transactions, in accordance with various examples of the present disclosure.

FIG. 7 illustrates a sequence diagram for performing an in-store transaction using a private label card that has been provisioned as tender for in-store merchant transactions, in accordance with various examples of the present disclosure.

FIG. 8 illustrates a sequence diagram for provisioning a private label card as tender for e-commerce transactions, in accordance with various examples of the present disclosure.

FIG. 9 illustrates a sequence diagram for performing an e-commerce using a private label card that has been provisioned as tender for e-commerce merchant transactions, in accordance with various examples of the present disclosure.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present disclosure provides systems and methods for providing platforms that are integrated to provision funds and perform electronic transactions for both in-store and e-commerce transactions. Consumers have many options for purchasing goods and services. The ability to process payments using a variety of funding sources offers a competitive advantage in the marketplace by allowing merchants to cater to the preferences of customers. Traditional in-store and e-commerce merchants are limited in the variety of funding or payment sources that are accepted. Accordingly, such merchants may be unable to process payments using some payment sources, such as electronic consumer wallets and/or private label cards, for example. These merchants may lose sales or otherwise inconvenience customers who have a preferred payment source. Thus, there is a need for integration of a variety of payment sources for both in-store and e-commerce transactions.

The present disclosure describes systems and methods that seamlessly integrate payment methods so that merchants are provided with the ability to perform transactions using payment sources, such as private label cards and electronic wallets. These systems and methods offer valuable improvements by providing a consistent interface for both in-store and online payments, which allows customers to pay the merchant using the customer's desired funding source.

These systems and methods include multiple computers that are communicatively coupled to transfer data. As described herein, a merchant provides a data center that is communicatively coupled to a white label platform (e.g., PAYDIANT®), a white label service provider (e.g., BRAINTREE®), and a consumer vault provider (e.g., PAYPAL®). The merchant's data center may receive provisioning and payment requests from the merchant's e-commerce site and/or consumer applications.

Provisioning and payment requests may be routed to the white label platform, which interacts with the merchant data center to provide a client token. The client token is used to initialize a software development kit (SDK) included on the merchant application that communicates with the merchant data center. The merchant data center may then communicate with a white label service provider or a consumer vault provider to provide consent for billing. After the consent for billing is provided, a merchant application may communicate with the white label platform to generate a customer identifier and create a payment token that is stored on the white label platform. Payments may be processed by providing the payment token to the white label platform, which may send a corresponding token to a consumer vault provider or to a white label service provider. The consumer vault provider or white label service provider may then access the customer account associated with the token to process the payment.

The techniques described by the present disclosures provide numerous advantages over conventional technology. These techniques allow for provisioning a plurality of funding sources to conduct payment transactions using the provisioned funding sources. Merchants may use these techniques to seamlessly add new funding sources to the funding sources already provided by existing infrastructures of the merchants. This allows merchants to have the flexibility to assess funding source needs and add new funding sources to supplement existing funding sources. Moreover, consumers may link their electronic wallet accounts to merchants in order to access the accounts and pay for goods and/or services of the merchants. Merchants may also use these techniques to provide the benefit of consistent interfaces for online and in-store payments. Of course, these advantages of the present technique are merely exemplary, and no particular advantage is required for any particular embodiment.

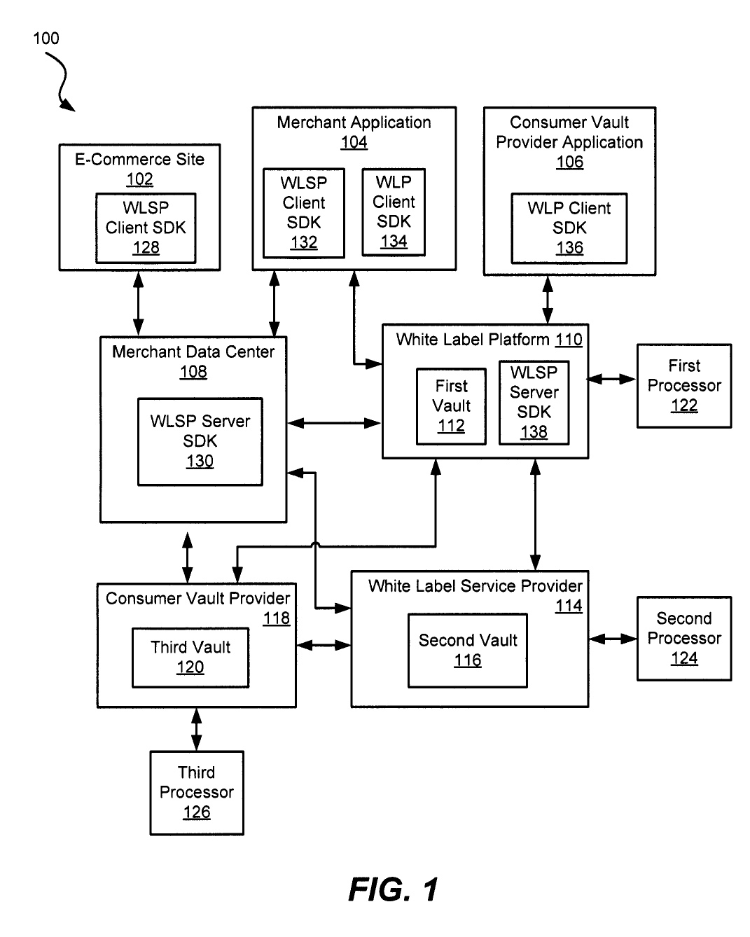

FIG. 1 illustrates a system architecture 100 for providing a hierarchical vault data structure, in accordance with various examples of the present disclosure.

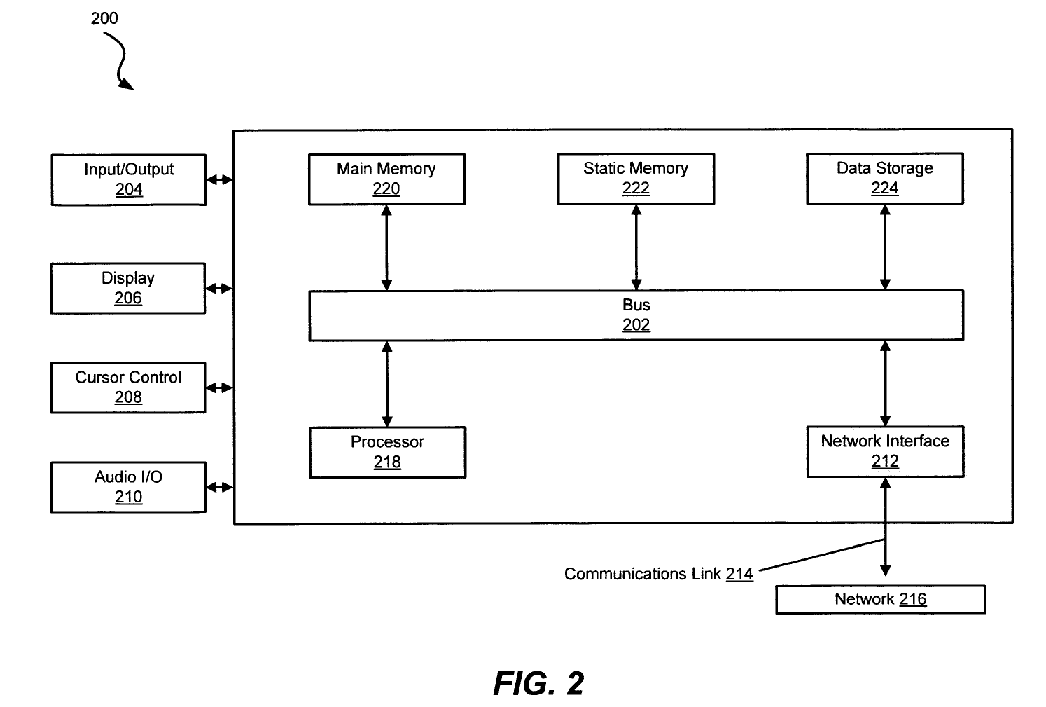

The system architecture 100 includes at least one computing device that may be adapted to implement one or more of the processes for transaction processing as discussed herein. In some examples, the computing devices are each structured as a computing system, such as the computing system 200 described with respect to FIG. 2.

In the present example, each of an e-commerce site 102, a merchant application 104, a consumer vault provider application 106, a merchant data center 108, a white label platform 110, a white label service provider 114, and a consumer vault provider 118 is structured on one or more computing devices that may be communicated coupled via a network, such as the Internet or other transmissions means using one or more transport media.

In the present example, the e-commerce site 102 is structured to provide an interface including a display to one or more consumers. The consumers may interact with the e-commerce site 102 via computing platforms to initiate transactions corresponding to one or more merchants. For example, the e-commerce site 102 may be structured as a website or other application-accessible site that may be accessed by consumers to browse products/services and make purchases corresponding to a merchant. In the present example the e-commerce site 102 is communicatively coupled to the merchant data center 108, such that the e-commerce site 102 may send transaction data to the merchant data center and receive transaction data from the merchant data center 108.

In the present example, the e-commerce site 102, merchant application 104, consumer vault provider application 106, merchant data center 108 and white label platform 110 are structured with one or more software development kits (SDKs) that provide interoperability between components. In some examples, each SDK includes a software component that translates and/or modifies inputs received from input components to provide outputs that are recognized by the output components. Moreover, the SDKs may also include one or more functions that provide communication features for sending and/or receiving data.

In the present example, e-commerce site 102 includes a white label service provider (WLSP) client SDK 128, a WLSP client component that provides interoperability between the e-commerce site 102 and the white label service provider 114. For example, the WLSP client SDK 128 may translate data at the e-commerce site 102 and communicate the translated data to a WLSP server SDK 130, a WLSP server component that is included at the merchant data center 108. The WLSP server SDK 130 receives the translated data and communicates with the white label service provider 114 to process the translated data on behalf of the merchant data center 108. The WLSP server SDK 130 communicates responses to the WLSP client SDK 128, which the WLSP client SDK 128 translates for processing at the e-commerce site 102.

In the present example, the WLSP Server SDK 130 is structured to expose payment capabilities that may be triggered from the merchant data center 108 to the white label service provider 114. In some examples, the WLSP Server SDK 130 drives a provisioning flow pertaining to billing agreements by invoking the Consumer Vault Provider. In some examples, the WLSP server SDK 130 communicates with the white label service provider 114 to store a billing agreement and/or billing agreement identifier in the context of a provisioning flow. In some examples, the billing agreement may be generated by a billing agreement component. The billing agreement component may be further structured to generate a billing agreement identifier. In some examples, the WLSP Server SDK 130 generates a payment method token which is stored on the white label platform 110 during a process of adding an electronic payment tender as part of the provisioning flow.

In the present example, the WLSP Client SDK 128 in structured to expose payment capabilities that may be triggered by a mobile client. The WLSP Client SDK 128 may facilitate a provisioning flow by initiating an agreement or consent flow with a WLSP Server SDK, such as WLSP server SDK 130 and/or WLSP server SDK 138 and the consumer vault provider 118. In some examples, the consumer agrees and provides consent based on the terms of an agreement with the wallet provider regarding the use of the consumer's wallet at the consumer vault provider 118 as tender for subsequent transactions. Accordingly, this consent may be accessed to bypass at least some authentication and authorization processes for the subsequent transactions. In the present example, the WLSP client SDK 128 uses a client token generated by the WLSP Server SDK 130 and/or WLSP server SDK 138 in the context of initialization. In some examples, the WLSP client SDK 128 is used in the context of addition of tender as part of a provisioning flow.

Merchant application 104 is structured to provide an interface at a merchant location, such that in-store transactions may be initiated at the merchant location with consumers. In the present example, the merchant application 104 is communicatively coupled to the merchant data center 108 and/or white label platform 110, such that merchant application 104 may send and receive transaction data with a backend system that processes transactions between the merchant and one or more consumers. The merchant Application 104 allows consumers to add a funding source as a tender. Examples of tender options include credit cards, debit cards, wallets of consumer vault providers, private label cards, gift cards and other offers.

In the present example, the merchant application 104 includes a white label service provider (WLSP) client SDK 132, a WLSP client component that provides interoperability between the merchant application 104 and the white label service provider 114. For example, the WLSP client SDK 132 may translate data at the merchant application 104 and communicate the translated data to the WLSP server SDK 130 that is included at the merchant data center 108. The WLSP server SDK 130 receives the translated data and communicates with the white label service provider 114 to process the translated data on behalf of the merchant data center 108. The WLSP server SDK 130 communicates responses to the WLSP client SDK 128, which the WLSP client SDK 128 translates for processing at the merchant application 104.

In the present example, the merchant application 104 includes a white label platform (WLP) client SDK 134, a WLP client component that provides interoperability between the merchant application 104 and the white label platform 110. For example, the WLP client SDK 134 may translate data at the merchant application 104 and communicate the translated data to the white label platform 110. The white label platform 110 receives the translated data for processing. The white label platform 110 communicates responses to the WLP client SDK 134, which the WLP client SDK 134 translates for processing at the merchant application 104. The WLSP client SDK 134 may be structured to include at least some features similar to those described with respect to the WLSP client SDK 128.

The WLP client SDK 134 allows a merchant application 104 to access capabilities provided by a white label platform 110 infrastructure to expose a merchant's wallet. In the present example, the WLP client SDK 134 provides the ability to perform authentication, on-board consumers onto the white label platform 110, and add various tenders, such as credit cards, debit cards, wallet of consumer vault providers, private label cards, gift cards, and other offers. In some examples, the WLP client SDK 134 allows addition of these tenders by supporting split-tenders. In the context of provisioning flows, such as to add an artifact (e.g., a wallet of consumer vault provider), the WLP client SDK 134 interacts with the white label platform 110 and the white label service provider 114 components. In some examples, transaction flows are triggered by the WLP client SDK 134.

The consumer vault provider application 106 may include an application provided by a third-party payment service provided by a consumer vault provider, such as consumer vault provider 118. For example, if the consumer vault provider 118 is PAYPAL®, the consumer vault provider application 106 may include a PAYPAL® application that is used to configure the white label platform 110 with access to PAYPAL® data on the consumer vault provider 118. In the present example, the consumer vault provider application 106 is communicatively coupled to the white label platform 110.

In the present example, the consumer vault provider application 106 includes a white label platform (WLP) client SDK 136, a WLP client component that provides interoperability between the consumer vault provider application 106 and the white label platform 110. For example, the WLP client SDK 136 may translate data at the consumer vault provider application 106 and communicate the translated data to the white label platform 110. The white label platform 110 receives the translated data for processing. The white label platform 110 communicates responses to the WLP client SDK 136, which the WLP client SDK 136 translates for processing at the consumer vault provider application 106. In some examples, the WLP client SDK 136 is structured to provide features similar to the features provided by the WLP client SDK 134.

The merchant data center 108 is structured as a data server and/or data store that includes merchant data, such as data corresponding to products/services offered by the merchant. The merchant may be, for example, an online retailer and/or in-store retailer. In the present example, the merchant data center 108 is communicatively coupled to the white label platform 110, the consumer vault provider 118, and the white label service provider 114, in addition to the e-commerce site 102 and the merchant application 104. The merchant data center may also be structured to include one or more merchant switch elements that operate to route data to other computing components in the system 100. Each merchant switch element may be structured as a switch, router, and/or other data routing computing device.

In the present example, the white label platform 110 is structured to provide a first vault 112 corresponding to a particular merchant, which in this example is the merchant that provides the merchant data center 108. The white label platform 110 may include a plurality of vaults, each corresponding to a different merchant. The White Label Platform exposes all the capabilities in the context of exposing and using a white label infrastructure for a Merchant's Wallet. In the present example, the white label platform 110 is structured to expose features for providing white label capabilities including federated identity management, multi-tenancy related to issuers and merchants, connector framework to communicate with processors and 3rd Party providers for private label cards, gift cards, offers and loyalty. It provides a message oriented and event driven infrastructure with application programming interfaces (APIs) related to Mobile and point-of-sale (POS) integrations.

The white label platform 110 may be a provider such as PAYDIANT®, which provides payment services to merchants for conducting transactions. The first vault 112 is structured as a vault that corresponds to a particular merchant, and stores data corresponding to the particular merchant. The vault may be a white label vault that provides the appearance of being provided by the merchant even though the vault is hosted by a different entity, such as the white label platform 110. In other words, the white label platform 110 may provide vaults for merchants that the merchants may identify as provided by the merchants. The first vault 112 may include data such as a token corresponding to the merchant's account on the white label service provider 114, an agreement between the merchant and the white label platform, and payment options for the merchant, such as credit card, debit card, private label credit card, PAYPAL®, coupons, and/or other offers. In the present example, the white label platform 110 is communicatively coupled to the white label service provider 114, in addition to the merchant application 104, the consumer vault provider application 106, and the merchant data center 108.

In the present example, the white label platform 110 includes a white label service provider (WLSP) server SDK 138, a WLSP server component that provides interoperability between the white label platform 110 and the white label service provider 114. For example, the WLSP server SDK 138 may translate data at the white label platform 110 and communicate the translated data to the WLSP server SDK 130 that is included at the merchant data center 108 and/or the white label service provider 114. The WLSP server SDK 130 and/or white label service provider 114 receives the translated data for further processing. The WLSP server SDK 130 and/or white label service provider 114 communicates responses to the WLSP server SDK 138, which the WLSP server SDK 138 translates for processing at the white label platform 110.

In the present example, the white label service provider 114 is structured to support payments, such as online payments. The white label service provider 114 may be a provider such as BRAINTREE®. The white label service provider 114 includes one or more vaults, such as second vault 116 that corresponds to a merchant. In the present example, the second vault 116 includes data corresponding to the merchant that provides the merchant data center 108. The second vault 116 may include data such as a token corresponding to a consumer's account on the consumer vault provider 118, an agreement between the consumer and the white label service provider, and payment options for the merchant, such as credit card, debit card, private label credit card, other card-based payment, PAYPAL®, coupons, and/or other offers. In the present example, the white label service provider 114 is communicatively coupled to the consumer vault provider 118, in addition to the white label platform 110 and the merchant data center 108.

In the present example, the white label service provider 114 may be used to store tokens corresponding to various payment methods including cards, 3^{rd} Party wallets, and so forth. White Label Service provider 114 can be used in the context of online or e-commerce transactions. White Label Service provider 114 also may connect to various processors to support the payment tokens stored in its vault. In some examples, the White Label Service provider 114 maintains a communicative coupling with one or more of the WLSP client SDK 128, WLSP client SDK 132, WLSP server SDK 130, and/or WLSP server SDK 138. In some examples, the white label service provider 114 may expose APIs through which provisioning of an artifact is enabled and may be used in the context of a transaction.

In the present example, the consumer vault provider 118 is structured to provide access to one or more vaults, such as a third vault 120 that corresponds to a particular consumer. The consumer vault provider 118 may be a provider such as PAYPAL® or other third-party consumer funding source. The third vault 120 may include data such as a balance corresponding to a consumer's account, and payment options for the consumer, such as credit card, debit card, private label credit card, other card-based payment method, coupons, and/or other offers. In the present example, the consumer vault provider 118 is communicatively coupled to the merchant data center 108 and the white label service provider 114.

In the present example, the consumer vault provider 118 is structured to provide capabilities related to a digital wallet provider. The consumer vault provider 118 may support balances, credit cards, debit cards, private label cards, gift cards, offers, coupons and loyalty offers. In some examples, the consumer vault provider 118 is structured to expose the ability to generate a billing agreement in the context of a consent from a consumer while adding a tender to a merchant's wallet. In some examples, the consumer vault provider 118 is responsible for handling end-to-end transactions from the infrastructure to external processors and 3^{rd} Party providers. In some examples, the consumer vault provider 118 manages pre-transaction, transaction and post-transaction activities, including settlements.

In the present example, each of the merchant data center 108, white label platform 110, white label service provider 114, and consumer vault provider 118 may utilize one or more data stores that are structured to store and provide data. In some examples, data stores may include relational databases, XML databases, flat files, and/or any other data store that is structured to store data. In other examples, one or more of the data stores may be provided by a web service that is accessed via a network to perform Input/Output (I/O) operations. The data stores may be homogenous or heterogeneous (e.g., one or more of the data stores may be structured as a relational database and one or more other data stores may be structured as an XML database or other database type). In some examples, the first vault 112, second vault 116, and third vault 120 are each structured in at least one relational database that includes one or more fields that is structured to store data corresponding to the vaults. For example, token data, payment options, and/or other data corresponding to the vaults may be included in one or more database tables that are structured using rows and columns.

In the present example, each token is structured as a cryptographic key that uniquely identifies a particular vault/wallet. For example, a token may be a generated string of symbols, which may include a combination of numbers, letters, and/or special characters.

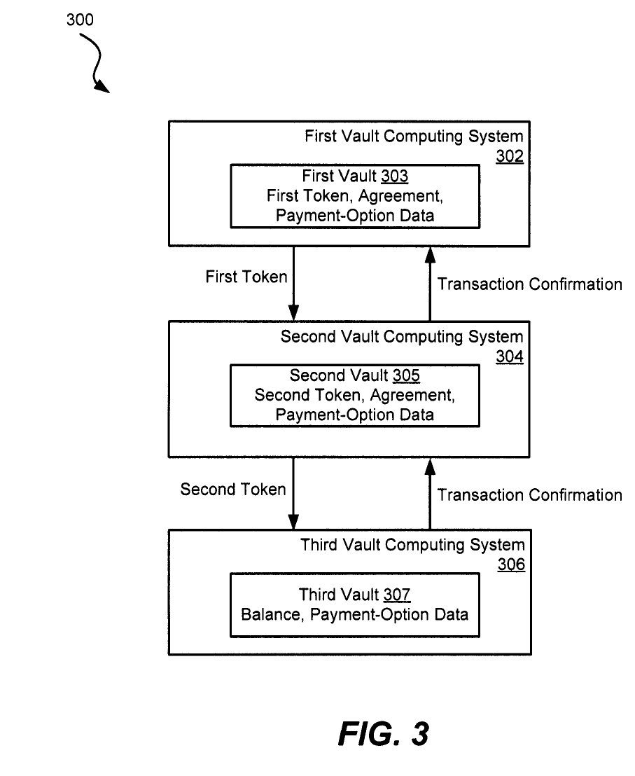

In the present example, the system 100 enables merchants to process payments across different platforms, such as online and in-store with a consistent interface, regardless of whether the merchant uses a white label platform (e.g., white label platform 110) for processing in-store transactions or a white label service provider (e.g., white label service provider 114) for processing online transactions. Consumers may link third-party funding sources, such as consumer wallets provided by a consumer vault provider 118, such as PAYPAL®, and/or other consumer vault providers. The present system also allows for merchants to use a single-access token that may be used for online, in-store, or peer-to-peer payments. A single-access token design is explained in more detail with respect to FIG. 3, which describes a merchant providing a first token to a first vault computing system, which stores a second token for accessing second vault computing system, which in turn stores a third token for accessing a third vault computing system. Additional features may also be provided in the system 100, such as refreshing tokens for use across the various vault computing systems.

FIG. 1. also shows a first processor 122, a second processor 124, and a third processor 126, where each processor is a payment processor that is structured to process transactions, such as payments, on behalf of a particular entity. As illustrated, the white label platform 110 is communicatively coupled to the first processor 122 that processes transactions/payments on behalf of the white label platform 110. Similarly, the white label service provider 114 is communicatively coupled to the second processor 124 that processes transactions/payments on behalf of the white label service provider 114. Further, the consumer vault provider 118 is communicatively coupled to the third processor 126 that processes transactions/payments on behalf of the consumer vault provider 118. In some examples, the processors 122, 124, and 126 operate as back-end payment processors that handle transactions by authenticating and performing the transactions to move funds between entities.

FIG. 2 illustrates an exemplary computer system 200 in block diagram format suitable for implementing on one or more devices of the system architecture in FIG. 1. In various implementations, computer system 200 may comprise a computing device, such as a smart or mobile phone, a computing tablet, a desktop computer, laptop, wearable device, rack mount server, and so forth. Computer system 200 may also comprise a one or more computing devices, which may be arranged in a cluster.

Computer system 200 may include a bus 202 or other communication mechanisms for communicating information data, signals, and information between various components of computer system 200. Components include an I/O component 204 that processes a user action, such as selecting keys from a keypad/keyboard, selecting one or more buttons, links, actuatable elements, etc., and sends a corresponding signal to bus 202. I/O component 204 may also include an output component, such as a display 206 and a cursor control 208 (such as a keyboard, keypad, mouse, touch screen, etc.). An optional audio I/O component 210 may also be included to allow a user to hear audio and/or use voice for inputting information by converting audio signals.

A network interface 212 transmits and receives signals between computer system 200 and other devices, such as user devices, data storage servers, payment provider servers, and/or other computing devices via a communications link 214 and a network 216 (e.g., such as a LAN, WLAN, PTSN, and/or various other wired or wireless networks, including telecommunications, mobile, and cellular phone networks).

The processor 218 represents one or more general-purpose processing devices such as a microprocessor, central processing unit, or the like. More particularly, processor 218 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 218 may also be one or more special-purpose processing devices such as an application specific integrated circuit (ASIC), a field programmable gate array (FPGA), a digital signal processor (DSP), network processor, or the like. Processor 218 is configured to execute instructions for performing the operations and steps discussed herein.

Components of computer system 200 also include a main memory 220 (e.g., read-only memory (ROM), flash memory, dynamic random access memory (DRAM) such as synchronous DRAM (SDRAM), double data rate (DDR SDRAM), or DRAM (RDRAM), and so forth), a static memory 222 (e.g., flash memory, static random access memory (SRAM), and so forth), and a data storage device 224 (e.g., a disk drive).

Computer system 200 performs specific operations by processor 218 and other components by executing one or more sequences of instructions contained in main memory 220. Logic may be encoded in a computer readable medium, which may refer to any medium that participates in providing instructions to processor 218 for execution. Such a medium may take many forms, including but not limited to, non-volatile media, volatile media, and/or transmission media. In various implementations, non-volatile media includes optical or magnetic disks, volatile media includes dynamic memory, such as main memory 220, and transmission media between the components includes coaxial cables, copper wire, and fiber optics, including wires that comprise bus 202. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 214 to the network 216 may perform instruction sequences to practice the present disclosure in coordination with one another. Modules described herein may be embodied in one or more computer readable media or be in communication with one or more processors to execute or process the steps described herein.

FIG. 3 is a block diagram illustrating a hierarchical vault data structure 300. In the present example, the hierarchical vault data structure 300 is implemented by multiple computing devices that transfer data corresponding to separate vaults.

The first vault in the hierarchical vault data structure is provided by a first vault computing system 302. In some examples, the first vault computing system 302 is structured as a white label platform computing system, such as white label platform 110 that is discussed with respect to FIG. 1. The first vault computing system 302 may include at least one vault, such as a first vault 303 that includes data such as a first token corresponding to a second vault 305 stored on a second vault computing system 304, an agreement between a merchant and an entity that provides the second vault computing system 304, and payment-option data corresponding to one or more payment funding sources available to the merchant. In some examples, the first token may be referred to as a merchant token.

The first vault computing system 302 is structured to send the first token to the second vault computing system 304, which receives the first token.

The second vault in the hierarchical vault data structure is provided by the second vault computing system 304. In some examples, the second vault computing system 304 is structured as a white label service provider computing system, such as white label service provider 114 that is discussed with respect to FIG. 1. The second vault computing system 304 may include at least one vault, such as the second vault 305 that includes data such as a second token corresponding to a third vault 307 stored on a third vault computing system 306, an agreement between a consumer and the entity that provides the third vault computing system 306, and payment-option data corresponding to one or more funding sources available to the merchant. In some examples, the second token may be referred to as a consumer token.

The second vault computing system 304 is structured to identify a vault corresponding to the first token, which in this example is the second vault 305. The second vault computing system 304 is structured to identify a token in the second vault 305 that is associated with a third vault 307. In this example the token in the second vault 305 that is associated with the third vault 307 is the second token. The second vault computing system 304 is structured to send the second token to the third vault computing system 306, which receives the second token.

The third vault 307 in the hierarchical vault data structure is provided by the third vault computing system 306. In some examples, the third vault computing system 306 is structured as a consumer vault computing system, such as consumer vault provider 118 that is discussed with respect to FIG. 1. The third vault computing system 306 may include at least one vault that includes data such as a balance corresponding to a consumer or other entity and payment-option data corresponding to one or more funding sources that are available to the consumer that is associated with to the third vault 307.

The third vault computing system 306 is structured to access the third vault 307 that is associated with the second token to modify the balance corresponding to the consumer that is associated with the third vault 307. After modifying the balance, the third vault computing system 306 is structured to send a transaction confirmation back to the second vault computing system 304. The transaction confirmation is sent to the first vault computing system 302 by the second vault computing system 304.

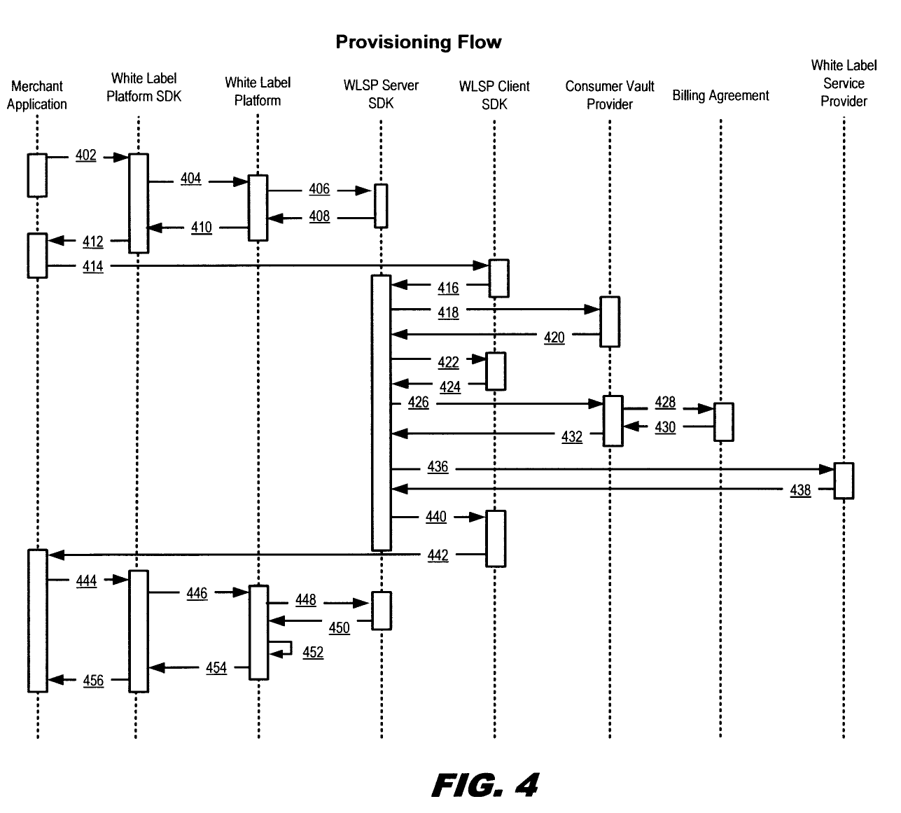

FIG. 4 illustrates a sequence diagram for provisioning an electronic wallet of a consumer vault provider as tender for in-store merchant transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method.

At action 402, the merchant application sends a provisioning request to a white label platform software development kit (SDK) component that is included in the merchant application. At action 404, the white label platform SDK formats the request and forwards the request to the white label platform. At action 406, responsive to receiving the formatted request, the white label platform sends a client token generation request to a white label service provider (WLSP) server SDK, which may be included at a merchant data center. At action 408, responsive to receiving the client token generation request, the WLSP server SDK generates the client token and sends the client token to the white label platform. At action 410, the white label platform forwards the client token to the white label platform SDK. At action 412, the white label platform SDK translates the communication and provides the client token to the merchant application.

At action 414, the merchant application initializes a WLSP client SDK using the client token. In some examples, the initializing includes configuring the WLSP client SDK to include the client token. This client token may also be provided in one or more outgoing communications from the WLSP server SDK. The WLSP client SDK may be included as a component of the merchant application. At action 416, the WLSP client SDK sends an authentication request to the WLSP server SDK. At action 418, the WLSP server SDK forwards the authentication request to the consumer vault provider, which is configured to include an electronic wallet corresponding to a consumer. At action 420, the consumer vault provider responds to the authentication request, indicating that the status of the request is accepted. At action 422, the WLSP server SDK forwards the status indicator to the WLSP client SDK. At action 424, the WLSP client SDK responds to the WLSP server by agreeing to consent to the creation of a billing agreement to allow the merchant to process customer payments using the customer's electronic wallet at the consumer vault provider. At action 426, the WLSP server forwards an indicator regarding the customer's agreement to the consumer vault provider.

At action 428, the consumer vault provider requests creation of a billing agreement, which may include performing one or more actions by a third-party billing agreement provider. At action 430, responsive to the billing agreement request, the billing agreement is created and associated with a billing agreement identifier that uniquely associates the billing agreement with the client token corresponding to the customer. The billing agreement identifier is provided to the consumer vault provider. At action 432, the billing agreement identifier is provided from the consumer vault provider to the WLSP server SDK, which stores the billing agreement identifier in a data store of the WLSP server SDK, such as a vault that stores tokens that are billing agreement identifiers. At action 436, the WLSP server SDK sends the billing agreement identifier to the white label service provider. The white label service provider stores the billing agreement identifier. At action 438, the white label service provider responds by sending a status indicator to the WLSP server SDK indicating that the billing agreement identifier is accepted.

At action 440, the WLSP server SDK sends a single-access token to the WLSP client SDK. In the present example, the single-access token is a random or pseudo random number that is cryptographically generated to help protect the integrity of the communication session. For example, the single-access token may be used in the communication session to associate the communications corresponding to the communication session with the particular communication session. At action 442, the WLSP client SDK responds to the receipt of the single-access token by sending a status indicator to the merchant application that indicates that the single-access token is accepted.

At action 444, the merchant application provides a request to the white label platform SDK to add the electronic wallet at the consumer vault provider as a tender option. At action 446, the white label platform SDK formats the request and provides the formatted request and the single-access token to the white label platform. At action 448, the white label platform sends a request to the WLSP server SDK to create a customer account that includes the electronic wallet as a funding source. The request includes a customer identifier corresponding to the customer and the single-access token. At action 450, the WLSP server SDK authenticates the request, based on the single-access token, and creates an account corresponding to the customer. The WLSP server SDK sends a communication to the white label platform that includes an identifier for the customer's account at the consumer vault provider. The communication includes a payment method token and the billing agreement identifier corresponding to the customer. At action 452, the white label platform stores the billing agreement identifier and the payment method token. At action 454, the white label platform sends a status indicator indicating acceptance to the white label platform SDK. At action 456, the white label platform SDK forwards the status indicator to the merchant application.

Accordingly, by performing actions 402-456, an account for the customer is created for payment of funds to the merchant using the customer's funds that are stored at the consumer vault provider. As a result of the provisioning performed in actions 402-456, there are several outcomes. First, the billing agreement identifier is stored in a data store at the WLSP server SDK. Second, the customer's account at the consumer vault provider is added as a tender at the white label platform, such as by adding a token corresponding to the customer's consumer vault provider account to a vault/data store maintained by the white label platform. Third, the billing agreement may also be cached at the white label platform for access in the context of a transaction.

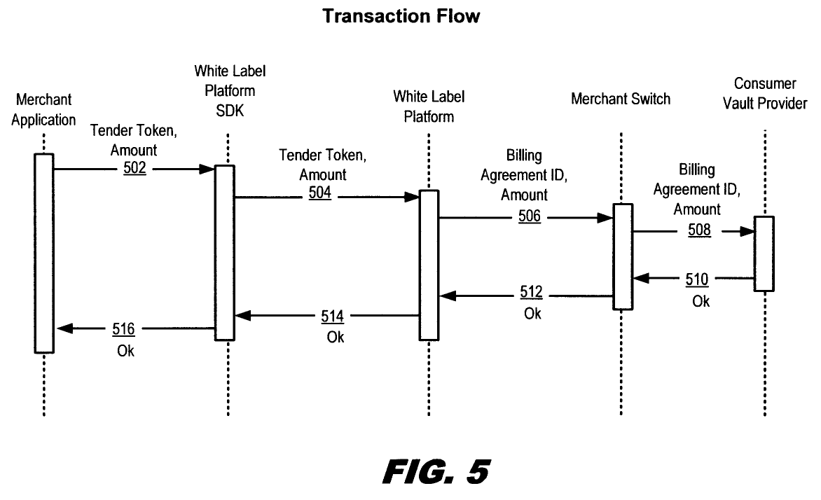

FIG. 5 illustrates a sequence diagram for performing an in-store transaction using an electronic wallet of a consumer vault provider that has been provisioned as tender for in-store merchant transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method.

At action 502, the merchant application sends a payment request to a white label platform SDK. The payment request includes a tender token corresponding to a customer that initiates the payment and also an amount corresponding to the payment. In the present example, the tender token may be a token such as the client token generated in step 408 in FIG. 4. The payment request is received by the white label platform SDK and formatted for sending to the white label platform. At action 504, the formatted payment request including the tender token and amount is sent from the white label platform SDK to the white label platform. At action 506, the white label platform determines the billing agreement identifier corresponding to the tender token, and sends the billing agreement identifier and the amount to a merchant switch. At action 508, the merchant switch forwards the billing agreement identifier and the amount to the consumer vault provider. The consumer vault provider processes a payment to the merchant from the electronic wallet that corresponds to the billing agreement identifier. The processing of the payment may include debiting the amount from the electronic wallet and crediting the amount to an account of the merchant.

At action 510, the consumer vault provider sends the merchant switch a status indicator that indicates that the payment was successfully processed. At action 512, the merchant switch forwards the status indicator to the white label platform. At action 514, the white label platform forwards the status indicator to the white label platform SDK. At action 516, the white label platform SDK forwards the status indicator to the merchant application.

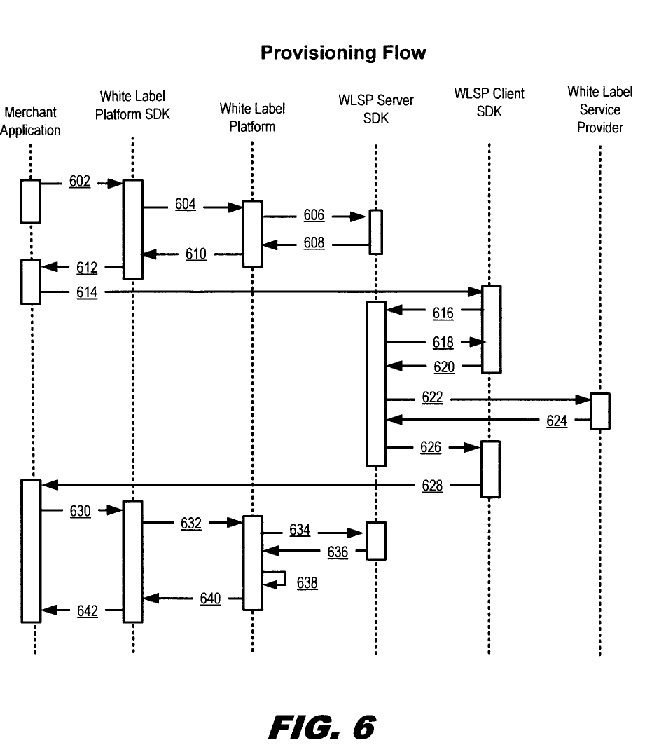

FIG. 6 illustrates a sequence diagram for provisioning a private label card as tender for in-store merchant transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method. In some examples, the private label card is a credit card that is provided by a private label card provider and branded by a merchant.

At action 602, the merchant application sends a provisioning request to a white label platform software development kit (SDK) component that is included in the merchant application. At action 604, the white label platform SDK formats the request and forwards the request to the white label platform. At action 606, responsive to receiving the formatted request, the white label platform sends a client token generation request to a white label service provider (WLSP) server SDK, which may be included at a merchant data center. At action 608, responsive to receiving the client token generation request, the WLSP server SDK generates the client token and sends the client token to the white label platform. At action 610, the white label platform forwards the client token to the white label platform SDK. At action 612, the white label platform SDK provides the client token to the merchant application.

At action 614, the merchant application initializes the WLSP client SDK using the client token. In some examples, the initializing includes configuring the WLSP client SDK to include the client token, such that the client token is provided in one or more outgoing communications from the WLSP client SDK. The WLSP client SDK may be included as a component of the merchant application. At action 616, the WLSP client SDK sends a request to the WLSP server SDK to begin a consent flow, which triggers one or more actions to obtain consent from the customer to the terms of an agreement so that the consumer's private label card may be added as a tender option to a wallet for further transactions. In some examples, the consumer is prompted to indicate an acceptance of the terms of the agreement. At action 618, the WLSP server SDK responds to the WLSP client SDK with a status indicator that indicates that the status is accepted. At action 620, the WLSP client SDK sends a private label card agreement to the WLSP server SDK. At action 622, the WLSP server SDK forwards an indicator regarding the customer's agreement to the white label service provider. This private label card agreement may be stored at a data store provided by white label service provider, such as in a white label service provider vault. At action 624, the white label service provider responds to the WLSP client SDK with a status indicator that indicates that the status is accepted.

At action 626, the WLSP server SDK sends a single-access token to the WLSP client SDK. In the present example, the single-access token is a random or pseudo random number that is cryptographically generated to help protect the integrity of the communication session. For example, the single-access token may be used in the communication session associate the communications corresponding to the communication session with the particular communication session. At action 628, the WLSP client SDK responds to the receipt of the single-access token by sending a status indicator to the merchant application that indicates that the single-access token is accepted.

At action 630, the merchant application provides a request to the white label platform SDK to add the private label card as a tender option. At action 632, the white label platform SDK formats the request and provides the formatted request and the single-access token to the white label platform. At action 634, the white label platform sends a request to the WLSP server SDK to create a customer. The request includes a generated customer identifier corresponding to the customer and the single-access token. At action 636, the WLSP server SDK authenticates the request, based on the single-access token, and creates an account corresponding to the customer. The WLSP server SDK sends a communication to the white label platform that includes an identifier for the customer's account at the white label service provider. The communication includes a payment method token. At action 638, the white label platform stores the payment method token and the private label card agreement that is associated with the white label card tender. At action 640, the white label platform sends a status indicator indicating acceptance to the white label platform SDK. At action 642, the white label platform SDK forwards the status indicator to the merchant application.

Accordingly, by performing actions 602-642, an account for the customer is created for payment of funds to the merchant using the customer's funds that are provided by a private label card. As a result of the provisioning performed in actions 602-642, there are several outcomes. First, the white label service provider may maintain the private label card agreement in a data store/vault. This private label card agreement is associated with the private label card of the customer. Second, the customer's private label card is added as a tender at the white label platform, such as by adding a token corresponding to the customer's private label card to a vault/data store maintained by the white label platform.

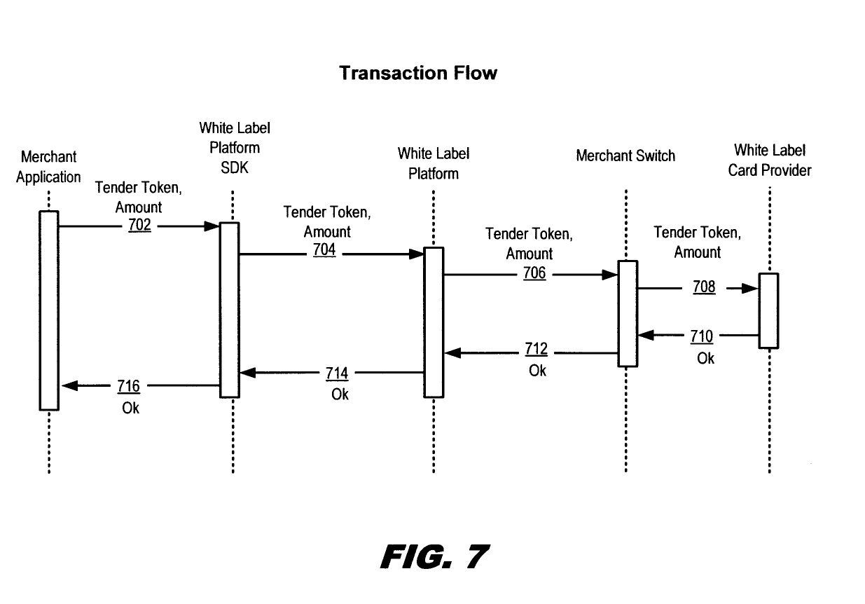

FIG. 7 illustrates a sequence diagram for performing an in-store transaction using a private label card that has been provisioned as tender for in-store merchant transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method.

At action 702, the merchant application sends a payment request to a white label platform SDK. The payment request includes a tender token corresponding to a customer that initiates the payment and also an amount corresponding to the payment. In the present example, the tender token may be a token such as the client token generated in step 608 in FIG. 6. The payment request is received by the white label platform SDK and formatted for sending to the white label platform. At action 704, the formatted payment request including the tender token and amount is sent from the white label platform SDK to the white label platform. At action 706, the white label platform forwards the tender token and the amount to a merchant switch. At action 708, the merchant switch forwards the tender token and the amount to a private label card provider, which processes a payment to the merchant from the customer that corresponds to the tender token. In this example, the private label card provider is a provider of the private label card that is branded by the merchant. The processing of the payment may include debiting the amount from an account of the customer corresponding to the private label card and crediting the amount to an account of the merchant.

At action 710, the private label card provider sends the merchant switch a status indicator that indicates that the payment was successfully processed. At action 712, the merchant switch forwards the status indicator to the white label platform. At action 714, the white label platform forwards the status indicator to the white label platform SDK. At action 716, the white label platform SDK forwards the status indicator to the merchant application.

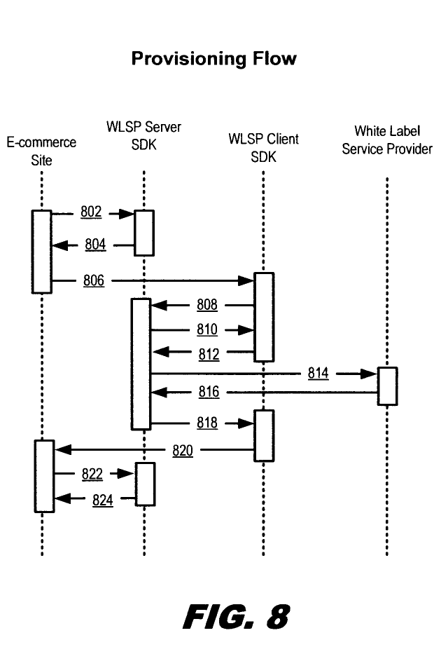

FIG. 8 illustrates a sequence diagram for provisioning a private label card as tender for e-commerce transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method. In some examples, the private label card is a white label private label credit card that is provided by a private label card provider and branded by an e-commerce site.

At action 802, an e-commerce site sends a provisioning request to a white label service provider (WLSP) server SDK, which may be included at a merchant data center. At action 804, responsive to receiving the request, the WLSP server SDK generates a client token and sends the client token to the e-commerce site.

At action 806, the e-commerce site initializes a WLSP client SDK using the client token. In some examples, the initializing includes configuring the WLSP client SDK to include the client token, such that the client token is provided in one or more outgoing communications from the WLSP client SDK. The WLSP client SDK may be included as a component of the e-commerce site. At action 808, the WLSP client SDK sends a request to the WLSP server SDK to begin a consent flow, which triggers one or more actions to obtain consent from the customer to the terms of an agreement so that the consumer's private label card may be added as a tender option to a wallet for further transactions. In some examples, the consumer is prompted to indicate an acceptance of the terms of the agreement. At action 810, the WLSP server SDK responds to the WLSP client SDK with a status indicator that indicates that the status is accepted. At action 812, the WLSP client SDK sends an agreement to consent to the WLSP server SDK. At action 814, the WLSP server SDK generates and sends a token corresponding to a private label card of the customer to the white label service provider. At action 816, the white label service provider responds to the WLSP client SDK with a status indicator that indicates that the status is accepted.

At action 818, the WLSP server SDK sends a single-access token to the WLSP client SDK. In the present example, the single-access token is a random or pseudo random number that is cryptographically generated to help protect the integrity of the communication session. For example, the single-access token may be used in the communication session associate the communications corresponding to the communication session with the particular communication session. At action 820, the WLSP client SDK responds to the receipt of the single-access token by sending a status indicator to the e-commerce site that indicates that the single-access token is accepted.

At action 822, the e-commerce site provides a request to the WLSP server SDK to generate a payment method token. At action 824, the WLSP server SDK generates the payment method token and returns the payment method token to the e-commerce site. Accordingly, by performing actions 802-824, a payment method token is provided to the e-commerce site that may be used to perform payment transactions.

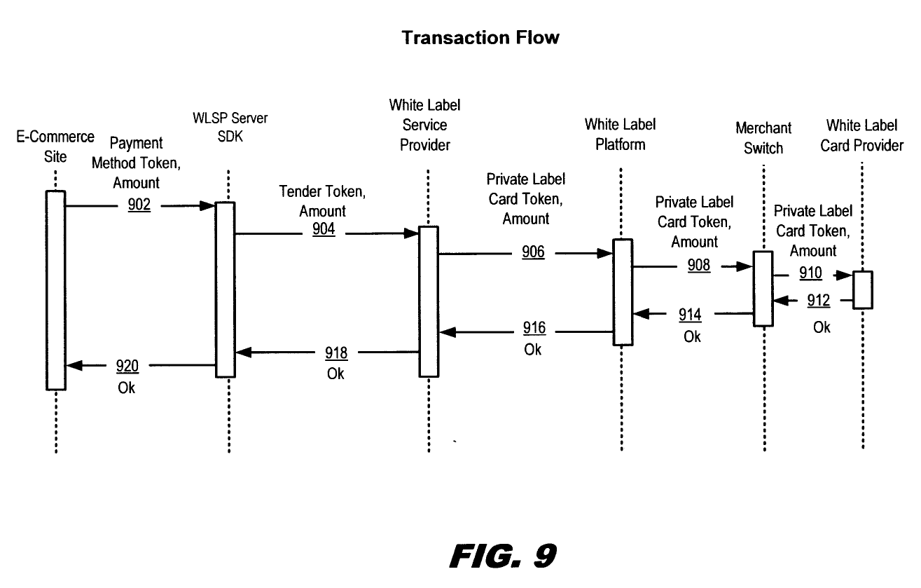

FIG. 9 illustrates a sequence diagram for performing an e-commerce transaction using a private label card that has been provisioned as tender for e-commerce transactions, in accordance with various examples of the present disclosure. In some examples, the method is implemented by one or more processors of a plurality of computing systems, which may each include a computing system architecture 200 as described with respect to FIG. 2, by executing computer-readable instructions to perform the functions described herein. It is understood that additional steps can be provided before, during, and after the steps of the method, and that some of the steps described can be replaced or eliminated in other examples of the method.

At action 902, the e-commerce site sends a payment request to a WLSP server SDK. The payment request includes a payment method token corresponding to a customer that initiates the payment and also an amount corresponding to the payment. In the present example, the payment method token may be a token such as the payment method token generated in step 824 in FIG. 8. The payment request is received by the WLSP server SDK. At action 904, the WLSP server SDK determines a tender token corresponding to the payment method token. The WLSP server SDK may query a vault data structure, such as a database, to identify the tender token corresponding to the payment method token. In the present example, the tender token may be a token such as the client token generated in step 804 in FIG. 8.

At action 906, the tender token and amount is sent from the WLSP server SDK to a white label service provider. The tender token and amount is received by the white label service provider. The white label service provider determines a token of a private label card that corresponds to the tender token. The white label service provider may query a vault data structure, such as a database, to identify the token of the private label card that corresponds to the tender token. In the present example, the token of the private label card may be a token such as the token corresponding to the private label card generated in step 814 in FIG. 8. The white label service provider sends the amount and the token corresponding to the private label card to the white label platform.

At action 908, the white label platform forwards the private label card token and the amount to a merchant switch. At action 910, the merchant switch forwards the private label card token and the amount to a private label card provider, which processes a payment to the merchant from the customer that corresponds to the private label card token. In this example, the private label card provider is a provider of the private label card that is branded by the e-commerce site. The processing of the payment may include debiting the amount from an account of the customer corresponding to the private label card and crediting the amount to an account of the e-commerce site.

At action 912, the private label card provider sends the merchant switch a status indicator that indicates that the payment was successfully processed. At action 914, the merchant switch forwards the status indicator to the white label platform. At action 916, the white label platform forwards the status indicator to the white label service provider. At action 918, the white label service provider forwards the status indicator to the WLSP server SDK. At action 920, the WLSP server SDK forwards the status indicator to the e-commerce site.

Where applicable, various embodiments provided by the present disclosure may be implemented using hardware, software, or combinations of hardware and software, which may be combined into composite components or sub-components comprising software, hardware, and/or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
provisioning a consumer vault provider to provide funds, the provisioning comprising:
generating a client token by a server component of a white label service provider;
providing the client token to a merchant application;
initializing, using the client token at the merchant application, a client component corresponding to the white label service provider;
providing a billing agreement, at least in part by one or more operations performed by the client component and the consumer vault provider, the billing agreement corresponding to a billing agreement identifier; and
providing the billing agreement identifier to the white label service provider; and
after provisioning the consumer vault provider, performing a transaction using the provisioned funds, the transaction comprising:
transmitting the client token from the merchant application to a white label platform;
determining, by the white label platform, the billing agreement identifier that corresponds to the client token;
transmitting the billing agreement identifier from the white label platform to the consumer vault provider; and
processing, by the consumer vault provider, a payment corresponding to the billing agreement identifier.

2. The system of claim 1, the operations further comprising:
sending a provisioning request from the merchant application to the white label platform, wherein the provisioning request is formatted by the client component prior to the provisioning request being communicated to the white label platform.

3. The system of claim 2, the operations further comprising:
communicating the provisioning request from the white label platform to the server component;
after generating the client token at the server component, routing the client token to the merchant application via the white label platform; and
formatting, at the client component, a communication from the white label platform that includes the client token.

4. The system of claim 1, the provisioning further comprising:
after providing the billing agreement identifier to the white label service provider, transmitting a token from the merchant application to the white label platform, wherein the token is generated by the server component; and
forwarding the token from the white label platform to the server component.

5. The system of claim 1, wherein the client token is stored in a first vault by the merchant application, and wherein the billing agreement identifier is stored in a second vault by the white label platform.

6. The system of claim 1, wherein the transmitting of the billing agreement identifier includes routing the billing agreement identifier to the consumer vault provider via a merchant switch.

7. The system of claim 1, wherein providing the billing agreement includes:
storing the billing agreement identifier at the server component;
providing the billing agreement identifier from the server component to the white label service provider;
generating a token by the server component; and
providing the token from the server component to the merchant application.

8. A non-transitory machine-readable medium having stored thereon machine-readable instructions executable to cause a machine to perform operations comprising:
transmitting a client token from a merchant application to a white label platform;
determining, by the white label platform, a billing agreement identifier that corresponds to the client token;
transmitting the billing agreement identifier from the white label platform to a consumer vault provider; and
processing, by the consumer vault provider, a payment corresponding to the billing agreement identifier.

9. The non-transitory machine-readable medium of claim 8, wherein the transmitting of the billing agreement identifier includes routing the billing agreement identifier to the consumer vault provider via a merchant switch.

10. The non-transitory machine-readable medium of claim 8, the operations further comprising provisioning the consumer vault provider to provide funds for the payment, the provisioning including:
generating the client token by a server component of a white label service provider;
providing the client token to the merchant application;
initializing, using the client token at the merchant application, a client component corresponding to the white label service provider;
providing a billing agreement, at least in part by one or more operations performed by the client component and the consumer vault provider, the billing agreement corresponding to the billing agreement identifier; and
providing the billing agreement identifier to the white label service provider.

11. The non-transitory machine-readable medium of claim 10, the provisioning further comprising:
after providing the billing agreement identifier to the white label service provider, transmitting a token from the merchant application to the white label platform, wherein the token is generated by the server component; and
forwarding the token from the white label platform to the server component.

12. The non-transitory machine-readable medium of claim 10, wherein providing the billing agreement includes:
storing the billing agreement identifier at the server component;
providing the billing agreement identifier from the server component to the white label service provider;
generating a token by the server component; and
providing the token from the server component to the merchant application.

13. The non-transitory machine-readable medium of claim 10, the provisioning further comprising:
sending a provisioning request from the merchant application to the white label platform, wherein the provisioning request is formatted by the client component prior to the provisioning request being communicated to the white label platform.

14. The non-transitory machine-readable medium of claim 13, the provisioning further comprising:
communicating the provisioning request from the white label platform to the server component;
after generating the client token at the server component, routing the client token to the merchant application via the white label platform; and
formatting, at the client component, a communication from the white label platform that includes the client token.

15. A method for performing an electronic transaction comprising:
transmitting a client token from a merchant application to a white label platform;
determining, by the white label platform, a billing agreement identifier that corresponds to the client token;
transmitting the billing agreement identifier from the white label platform to a consumer vault provider; and
processing, by the consumer vault provider, a payment corresponding to the billing agreement identifier.

16. The method of claim 15, wherein the transmitting of the billing agreement identifier includes routing the billing agreement identifier to the consumer vault provider via a merchant switch.

17. The method of claim 15, further comprising provisioning the consumer vault provider to provide funds for the payment, the provisioning including:
generating the client token by a server component of a white label service provider;
providing the client token to the merchant application;
initializing, using the client token at the merchant application, a client component corresponding to the white label service provider;
providing a billing agreement, at least in part by one or more operations performed by the client component and the consumer vault provider, the billing agreement corresponding to the billing agreement identifier; and
providing the billing agreement identifier to the white label service provider.

18. The method of claim 17, wherein providing the billing agreement includes:
storing the billing agreement identifier at the server component;
providing the billing agreement identifier from the server component to the white label service provider;
generating a token by the server component; and
providing the token from the server component to the merchant application.

19. The method of claim 17, the provisioning further comprising:
sending a provisioning request from the merchant application to the white label platform, wherein the provisioning request is formatted by the client component prior to the provisioning request being communicated to the white label platform.

20. The method of claim 19, the provisioning further comprising:
communicating the provisioning request from the white label platform to the server component;
after generating the client token at the server component, routing the client token to the merchant application via the white label platform; and
formatting, at the client component, a communication from the white label platform that includes the client token.
